(19) United States
(12) Patent Application Publication
(10) Pub. No.: US 2018/0246053 A1
(43) Pub. Date: Aug. 30, 2018

(54) MICROBIAL FUEL CELL SYSTEM

(71) Applicant: SHARP KABUSHIKI KAISHA, Sakai City, Osaka (JP)

(72) Inventors: MAKOTO TOGO, Sakai City, Osaka (JP); HIDEKAZU SHIMA, Sakai City, Osaka (JP)

(21) Appl. No.: 15/756,199

(22) PCT Filed: Aug. 23, 2016
(86) PCT No.: PCT/JP2016/074537

§ 371 Date: Feb. 28, 2018

(30) Foreign Application Priority Data
Mar. 18, 2016 (JP) 2016-056092

(51) Int. Cl. G01N 27/327

(52) U.S. Cl. CPC G01N 27/3277; H01M 8/16

(57) ABSTRACT

A change in electromotive force of a microbial fuel cell is sensed and visualized by use of electric supply from the microbial fuel cell. A sensing section (8) and an output section (9) are configured to be powered by the electromotive force of a microbial fuel cell (100).

### TECHNICAL FIELD

The present invention relates to a microbial fuel cell system in which a microbial fuel cell is used to visualize a function of an exoelectrogen.

### BACKGROUND ART

In recent years, attention has been drawn to IoT (Internet of Things) technologies, which have led to an increased need for distributed sensors and wireless transceivers. Such distributed sensors and wireless transceivers are desirably supplied with electricity stably in a wireless manner.

Meanwhile, a microbial fuel cell, which utilizes a function of exoelectrogens, has been considered for application as a sensor, not as a power source. Such techniques are disclosed in, for example, Patent Literature 1 and Non-patent Literature 1.

### CITATION LIST

### Patent Literature

[Patent Literature 1]
Japanese Patent Application Publication Tokuhyo No. 2013-513125 (Publication date: Apr. 18, 2013)

### Non-Patent Literature

[Non-Patent Literature 1]
http://www.aqua-ckc.jp/news/C-13_korbi_BOD.pdf (Jul. 6, 2010)

### SUMMARY OF INVENTION

### Technical Problem

However, the techniques disclosed in Patent Literature 1 and Non-patent Literature 1 both require external supply of electricity. In other words, the techniques disclosed in Patent Literature 1 and Non-patent Literature 1 both have an issue in that it is not possible to achieve a system which visualizes a function of exoelectrogens while obtaining electricity by utilizing the function of exoelectrogens.

The present invention was made in view of the above issue, and an object of the present invention is to provide a microbial fuel cell system in which a change in electromotive force of a microbial fuel cell is sensed and visualized by use of electric supply from the microbial fuel cell.

### Solution to Problem

In order to attain the above object, a microbial fuel cell system in accordance with an aspect of the present invention includes: a microbial fuel cell; a sensing section configured to sense an electromotive force of the microbial fuel cell; and an output section configured to output a result of sensing with the sensing section, the sensing section and the output section being configured to be powered by the electromotive force of the microbial fuel cell.

### Advantageous Effects of Invention

According to an aspect of the present invention, it is possible to sense and visualize a change in electromotive force of a microbial fuel cell by use of electric supply from the microbial fuel cell.

### BRIEF DESCRIPTION OF DRAWINGS

FIG. 1 is a cross-sectional view schematically showing a microbial fuel cell system in accordance with Embodiment 1 of the present invention.

FIG. 2 is a cross-sectional view schematically showing a microbial fuel cell system in accordance with Embodiment 2 of the present invention.

FIG. 3 is a cross-sectional view schematically showing a microbial fuel cell system in accordance with Embodiment 3 of the present invention.

FIG. 4 is a block diagram schematically showing a microbial fuel cell system in accordance with Embodiment 4 of the present invention.

FIG. 5 is a block diagram schematically showing a microbial fuel cell system in accordance with Embodiment 5 of the present invention.

FIG. 6 is a block diagram schematically showing a microbial fuel cell system in accordance with Embodiment 6 of the present invention.

FIG. 7 is a block diagram schematically showing a microbial fuel cell system in accordance with Embodiment 7 of the present invention.

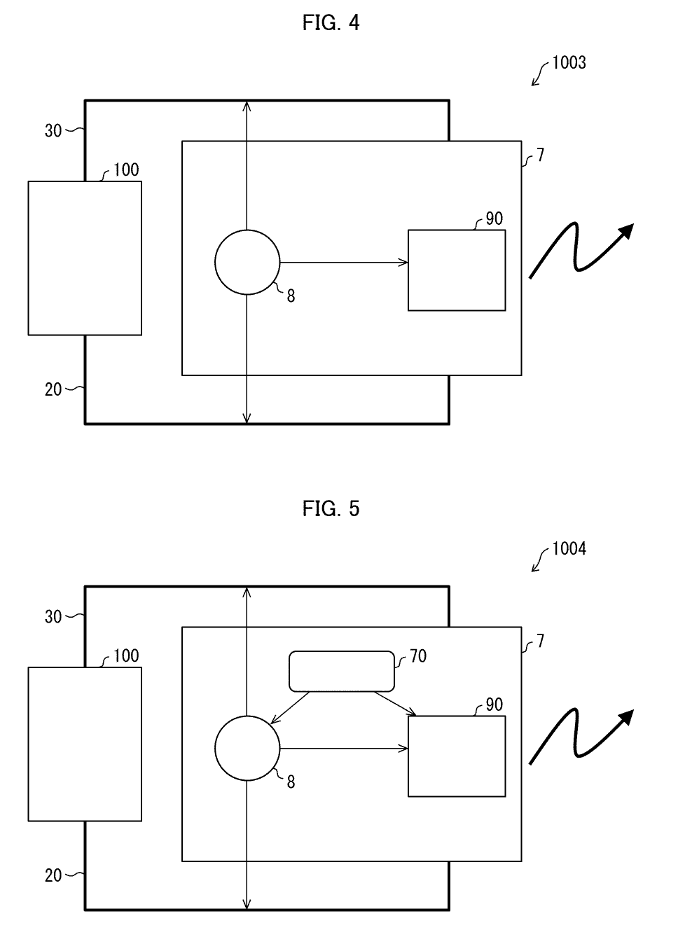

(a) of FIG. 8 is a graph showing an example of how a voltage of the microbial fuel cell of the microbial fuel cell system shown in FIG. 4 changes with time. (b) of FIG. 8 is a graph showing an example of how an electric current consumed by the control section of the microbial fuel cell of the microbial fuel cell system shown in FIG. 4 changes with time.

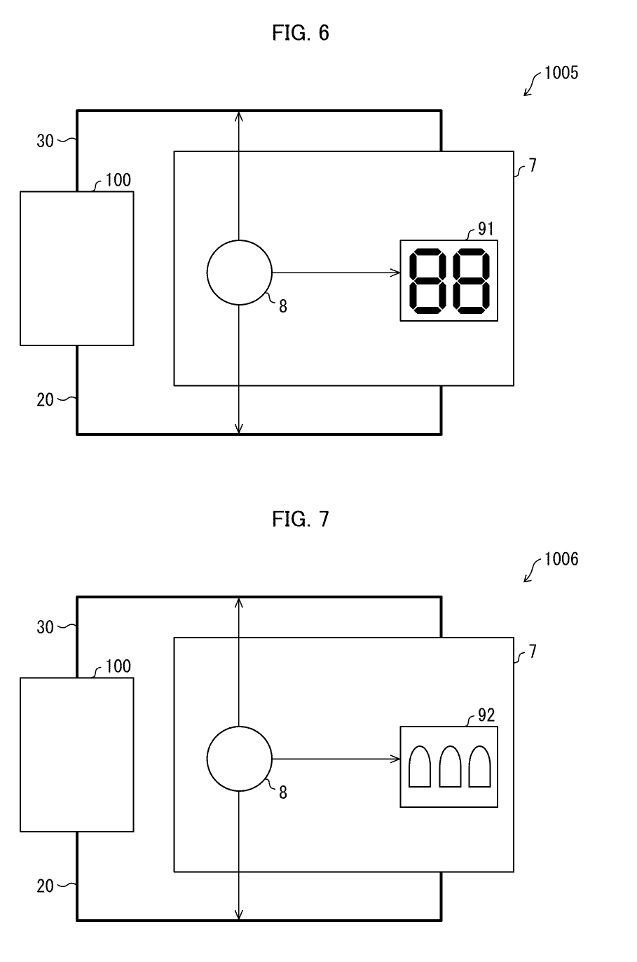

(a) of FIG. 9 is a graph showing an example of how a voltage of the microbial fuel cell of the microbial fuel cell system shown in FIG. 5 changes with time. (b) of FIG. 9 is a graph showing an example of how an electric current consumed by the control section of the microbial fuel cell of the microbial fuel cell system shown in FIG. 5 changes with time.

### DESCRIPTION OF EMBODIMENTS

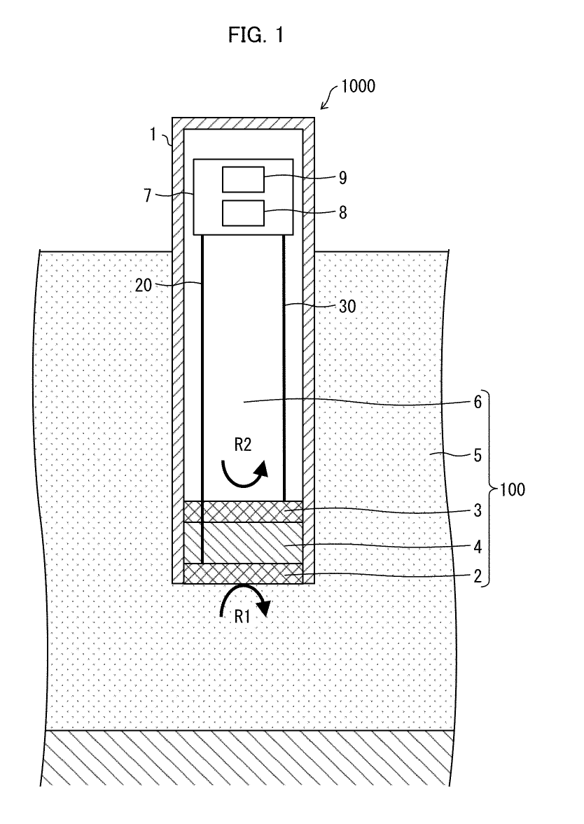

The following description will discuss embodiments of the present invention with reference to FIGS. 1 through 9. For convenience, any member having a function identical to that of a previously-described member will be assigned an identical reference number, and a description thereof will be omitted.

### Embodiment 1

FIG. 1 is a cross-sectional view schematically showing a microbial fuel cell system 1000 in accordance with Embodiment 1. The following description will discuss the microbial fuel cell system 1000 in detail with reference to FIG. 1. The microbial fuel cell system 1000 shown in FIG. 1 includes a microbial fuel cell 100, a housing 1, a control section 7, a negative electrode wire 20, and a positive electrode wire 30. The microbial fuel cell 100 includes a negative electrode 2, a positive electrode 3, an ion-conductive member 4, a microorganism-containing layer 5, and an air layer 6. The control section 7 includes a sensing section 8 and an output section 9.

The housing 1 houses therein the negative electrode 2, the positive electrode 3, the ion-conductive member 4, the air layer 6, the control section 7, the negative electrode wire 20, and the positive electrode wire 30. The housing 1 has an opening, which is blocked with the ion-conductive member 4.

The negative electrode 2 and the positive electrode 3, both serving as electrodes, are provided such that the ion-conductive member 4 is sandwiched between them. The negative electrode 2 is provided so as to be closer to the outside of the housing 1 than the ion-conductive member 4 is to the outside of the housing 1, whereas the positive electrode 3 is provided so as to be closer to the center of the housing 1 than the ion-conductive member 4 is to the center of the housing 1. The negative electrode wire 20 is a wire via which the negative electrode 2 and the control section 7 are electrically connected. The positive electrode wire 30 is a wire via which the positive electrode 3 and the control section 7 are electrically connected.

The ion-conductive member 4 is configured to allow ions to move between the negative electrode 2 and the positive electrode 3. In the microbial fuel cell system 1000, the ion-conductive member 4 is an ion-conductive film containing an electrolyte, and the negative electrode 2 is in contact with one side of the ion-conductive film whereas the positive electrode 3 is in contact with the other side of the ion-conductive film. Alternatively, the following arrangement can be employed: the ion-conductive member 4 is an electrolyte solution; and the negative electrode 2 and the positive electrode 3 are in contact with the electrolyte solution. Alternatively, the following arrangement can be employed: the ion-conductive member 4 is a hydrogel containing an electrolyte; and the negative electrode 2 and the positive electrode 3 are in contact with the hydrogel. Alternatively, the following arrangement can be employed: the ion-conductive member 4 is constituted by an ion-conductive film and an electrolyte solution; and the negative electrode 2 and the positive electrode 3 are each in contact with at least one of the ion-conductive film and the electrolyte solution. Alternatively, the ion-conductive member 4 can be made of one or more substances to achieve appropriate ion conductivity and/or oxygen permeability. In this case, the negative electrode 2 and the positive electrode 3 can be in contact with different substances. Note that the negative electrode 2 and the ion-conductive member 4 are not necessarily in contact with each other, and can have therebetween a member, other than the ion-conductive member 4, that allows movement of ions (such as, for example, the microorganism-containing layer 5).

The negative electrode 2 can be made of a well-known electrode material. In particular, the negative electrode 2 preferably contains a carbon material having high corrosion resistance, and is preferably made of, for example, carbon felt. The negative electrode 2 can be produced by applying a carbon coating to a base material made of metal. A preferable example of the base material is a stainless steel (SUS) mesh with a large surface area. The carbon coating can be applied by (i) forming a carbon plating by using a molten salt, (ii) applying non-woven fabric to a base material, (iii) applying a carbon-containing paint, (iv) sputtering, or the like. The positive electrode 3 can have the same configuration as that of the negative electrode 2.

Furthermore, the following method is known in recent years: a method of improving efficiency by using an enzyme or microorganism as an electrode catalyst. The negative electrode 2 and/or the positive electrode 3 can be coated with a medium containing an enzyme or microorganism in accordance with this method. In such a case, the negative electrode 2 and/or the positive electrode 3 are/is preferably in contact with the ion-conductive member 4 with the coating between itself and the ion-conductive member 4.

The microorganism-containing layer 5 is a layer that contains an exoelectrogen and organic matter. The microorganism-containing layer 5 surrounds the housing 1 and the negative electrode 2 so as to be in contact with the negative electrode 2. The air layer 6 is a layer that contains oxygen. The air layer 6 is constituted by a space in the housing 1 and is in contact with the positive electrode 3.

In the microbial fuel cell system 1000, the exoelectrogen resides on a surface of the negative electrode 2 which surface is in contact with the microbes-containing layer 5. The exoelectrogen, which is contained in the microorganism-containing layer 5 and which resides on the negative electrode 2, is, for example, an anaerobic exoelectrogen. Specific examples of the anaerobic exoelectrogen include well-known bacteria such as Shewanella species, Geobacter species, Rhodoferax ferrireducens, and Desulfobulbus propionicus. Of these, Shewanella species are suitable as the exoelectrogen contained in the microorganism-containing layer 5 and residing on the negative electrode 2, because Shewanella species are contained in many kinds of soil in abundance and easily donate electrons to the anode electrode.

The negative electrode wire 20 and the positive electrode wire 30 are each preferably made of a highly corrosion-resistant material such as stainless steel, titanium, nickel, or carbon. These materials are preferably covered with an insulating resin or the like.

The housing 1 is preferably made of an insulator or an insulated material, each of which prevents current flow at least between the negative electrode 2 and the positive electrode 3. Specific examples of the material for the housing 1 include generally-used resin (or rubber) materials, fluorine-based resin (or rubber) materials, metal materials with insulation coating, and ceramic materials. Of these, the material for the housing 1 is preferably a fluorine-based resin (or rubber) material because of its low cost and high corrosion resistance.

The ion-conductive member 4 can be obtained by, for example, mixing a salt such as potassium chloride or sodium chloride into agar. Alternatively, the ion-conductive member 4 can be, for example, Nafion (registered trademark) manufactured by DuPont.

FIG. 1 shows the microbial fuel cell system 1000 whose housing 1 is buried in the microorganism-containing layer 5. The microorganism-containing layer 5 is preferably soil that is rich in anaerobic exoelectrogens, and is preferably, for example, leaf mold. Alternatively, the microorganism-containing layer 5 can have a high moisture content, that is, may be in the form of mud. The microorganism-containing layer 5 can be dirty water or waste water. Known examples of the anaerobic exoelectrogen contained in the microbes-containing layer 5 include Shewanella species and the like described earlier.

As shown in FIG. 1, at the negative electrode 2, Reaction R1 takes place by decomposition of the organic matter through the metabolism by the exoelectrogen (i.e., decomposition of the organic matter by the exoelectrogen).

Examples of the organic matter contained in the microorganism-containing layer 5 include organic compounds such as glucose, acetic acid, and lactic acid. The electrons produced in Reaction R1 are collected at the negative electrode 2, whereas the protons produced in Reaction R1 travel from the negative electrode 2 to the positive electrode 3 through the ion-conductive member 4. The electrons produced in Reaction R1 then travel toward the positive electrode 3 through the negative electrode wire 20. At the positive electrode 3, Reaction R2 takes place in which the protons having travelled from the negative electrode 2 to the positive electrode 3 through the ion-conductive member 4, the electrons produced in Reaction R1, and oxygen contained in the air layer 6. Reactions R1 and R2 are described below.

(Organic matter in microorganism-containing layer 5)+2H₂O->CO₂+H⁺+e⁻ (Reaction R1)

O₂+4H⁺+4e⁻->2H₂O (Reaction R2)

The cycle of Reactions R1 and R2 causes an electromotive force of the microbial fuel cell 100 between the negative electrode wire 20 and the positive electrode wire 30. A change in this electromotive force is correlated with (i) a change in the amount of the organic matter contained in the microorganism-containing layer 5 and (ii) a change in the number (i.e., activity) of exoelectrogens.

The end of the negative electrode wire 20 opposite the negative electrode 2, and the end of the positive electrode wire 30 opposite the positive electrode 3, are both connected to the control section 7. This allows the sensing section 8 and the output section 9, which constitute the control section 7, to be powered by the electromotive force of the microbial fuel cell 100. In other words, the sensing section 8 and the output section 9 are each configured to be powered by the electromotive force of the microbial fuel cell 100. The sensing section 8 serves to sense the electromotive force of the microbial fuel cell 100. The output section 9 serves to output a result of sensing with the sensing section 8 and provide a notification of the result such that the result is perceivable, for example, outside the microbial fuel cell system 1000. Specific examples of the sensing section 8 and the output section 9 will be described later.

In the microbial fuel cell system 1000, the surface of the negative electrode 2 opposite the ion-conductive member 4 is exposed and thus is in contact with the microorganism-containing layer 5 with no limitation. Anaerobic exoelectrogens which are contained in the microorganism-containing layer 5 and which contribute to electricity generation are replaced in the natural ecosystem, and thus the surface of the negative electrode 2 can keep anaerobic exoelectrogens thereon. The microbial fuel cell system 1000 is therefore able to semi-permanently generate electricity, provided that no deterioration occurs in the negative electrode 2, the positive electrode 3, the negative electrode wire 20, or the positive electrode wire 30. This makes it possible to use, for a long period of time, the control section 7 which is connected with the negative electrode wire 20 and the positive electrode wire 30 and which includes the sensing section 8 and the output section 9.

According to the microbial fuel cell system 1000, the sensing section 8 and the output section 9 are powered by the electromotive force of the microbial fuel cell 100. This makes it possible to achieve a microbial fuel cell system 1000 in which a change in electromotive force of the microbial fuel cell 100 is sensed and visualized by use of electric supply from the microbial fuel cell 100.

### Embodiment 2

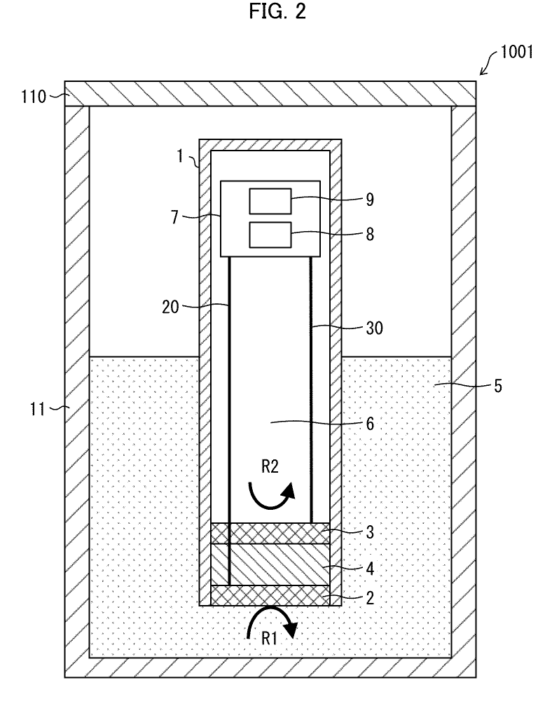

FIG. 2 is a cross-sectional view schematically showing a microbial fuel cell system 1001 in accordance with Embodiment 2. The following description will discuss the microbial fuel cell system 1001 in detail with reference to FIG. 2. The microbial fuel cell system 1001 shown in FIG. 2 is the same in configuration as the microbial fuel cell system 1000 shown in FIG. 1, except for the following configuration.

Specifically, the microbial fuel cell system 1001 further includes a housing 11. The housing 11 is provided outside a housing 1 and houses therein the housing 1 and a microorganism-containing layer 5. In other words, the microorganism-containing layer 5 is provided in a space between the outer wall of the housing 1 and the inner wall of the housing 11. That is, in the microbial fuel cell system 1001, the microorganism-containing layer 5 is provided in a limited space.

According to the microbial fuel cell system 1001, it is possible to know a change in state of the limited microorganism-containing layer 5 through the control section 7. The housing 11 is preferably, for example, a treatment tank for wet waste, dirty water, or the like, or a planter for growing plants. The housing 11 can have, in at least part thereof, a hole for water drainage and/or for addition of nutrients. The space between the housing 11 and the housing 1 can be filled with the microorganism-containing layer 5. Alternatively, the space can include the microorganism-containing layer 5 and, for example, air, which are bordered by each other. In other words, the space is not necessarily filled up with the microbes-containing layer 5.

The housing 11 has a lid 110, which can be detachably attached to the housing 11. The method of producing the microbial fuel cell system 1001 preferably includes (i) a step of placing each constituent in the housing 1, (ii) a step of placing the microorganism-containing layer 5 in the housing 11, and (iii) a step of sticking the housing 1 into the microorganism-containing layer 5 and then hermetically closing the housing 11 with the lid 110. The housing 11 is hermetically closed mainly to retain moisture of the microorganism-containing layer 5. The housing 11 is preferably kept in a hermetically closed state at least while electricity is being generated.

### Embodiment 3

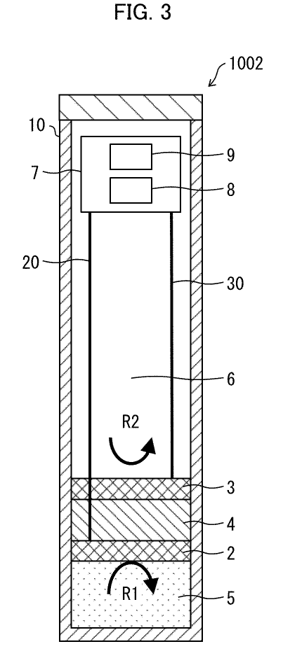

FIG. 3 is a cross-sectional view schematically showing a microbial fuel cell system 1002 in accordance with Embodiment 3. The following description will discuss the microbial fuel cell system 1002 in detail with reference to FIG. 3. The microbial fuel cell system 1002 shown in FIG. 3 is the same in configuration as the microbial fuel cell system 1000 shown in FIG. 1, except for the following configuration.

Specifically, the microbial fuel cell system 1002 includes a housing 10 instead of the housing 1. The housing 10 does not have the opening which is blocked with the ion-conductive member 4 in the housing 1. Furthermore, in the microbial fuel cell system 1002, a microorganism-containing layer 5 does not surround the housing 10. A space is formed between a negative electrode 2 and the bottom of the housing 10, in which space the microorganism-containing layer 5 is provided.

According to the microbial fuel cell system 1002, it is possible to know a change in state of the limited microorganism-containing layer 5 through the control section 7. For example, use of the microbial fuel cell system 1002 as a sensor enables sensing of a change in environment surrounding the housing 10. Appropriate selection of the material for and the configuration of the housing 10 enables sensing of a change in parameter that is correlated with the reaction cycle of the microbial fuel cell 100 (see FIG. 1), such as, for example, a change in temperature, humidity, atmospheric pressure, concentration of organic content, and/or illuminance around the housing 10. Furthermore, the housing 10 can have, for example, a function of adsorbing a specific component or a function of selectively allowing a specific component to pass through it. The housing 10 can be made of, for example, a filter that restricts the size of a substance that can pass through it, a porous material that adsorbs substances, an ion-exchange film which selectively adsorbs molecules, or a combination thereof.

### Embodiment 4

FIG. 4 is a block diagram schematically showing a microbial fuel cell system 1003 in accordance with Embodiment 4. The following description will discusses the microbial fuel cell system 1003 in detail with reference to FIG. 4. For simplicity, the housing of the microbial fuel cell system 1003 is not illustrated or described.

The microbial fuel cell system 1003 includes a microbial fuel cell 100, a negative electrode wire 20, a positive electrode wire 30, and a control section 7. The microbial fuel cell 100 is electrically connected to the control section 7 via the negative electrode wire 20 and the positive electrode wire 30.

The control section 7 includes a sensing section 8 and a wireless transmission section 90. The wireless transmission section 90 is one specific example of the output section 9 (see FIG. 1).

The sensing section 8 is constituted by, for example, (i) a load connected between the negative electrode wire 20 and the positive electrode wire 30 and (ii) a well-known sensing circuit configured to sense a voltage and/or an electric current applied to the load. A result of sensing with the sensing section 8 is transmitted from the wireless transmission section 90 to the outside of the microbial fuel cell system 1003 via data transmission (wireless communication).

The sensing section 8 can be configured such that: a threshold is set in advance; and, when, for example, a voltage applied to the load has exceeded or has become equal to or lower than the threshold voltage Vth, the sensing section 8 performs analog/digital conversion. That is, the sensing section 8 can be configured to change the result of sensing according to whether a sensed value, which corresponds to the magnitude of the electromotive force of the microbial fuel cell 100, is greater than a predetermined threshold.

The following description will discuss, with reference to (a) and (b) of FIG. 8, points in time at which the wireless transmission section 90 outputs the result. (a) of FIG. 8 is a graph showing an example of how a voltage (electromotive voltage) V of the microbial fuel cell 100 of the microbial fuel cell system 1003 changes with time. (b) of FIG. 8 is a graph showing an example of how an electric current I consumed by the control section 7 of the microbial fuel cell system 1003 changes with time.

In (a) of FIG. 8, the voltage V (corresponding to the voltage applied to the load) exceeds or becomes equal to or lower than the threshold voltage Vth at time t1 (exceeds), time t2 (becomes equal to or lower), and time t3 (exceeds). At times t1, t2, and t3, the sensing section 8 senses a change in voltage applied to the load. The wireless transmission section 90 converts the result of the sensing into data, and transmits the data.

In the meantime, as shown in (b) of FIG. 8, the electric current I consumed by the control section 7 temporarily increases right after times t1, t2, and t3, because the wireless transmission section 90 consumes an electric current to transmit the result of sensing at times t1, t2, and t3. Note that an electric current value Id indicates the value of an electric current that is always necessary to maintain the sensing section 8 and the wireless transmission section 90 in a stand-by state.

According to (a) and (b) of FIG. 8, in a case where some change occurs in the voltage V due to the electromotive force of the microbial fuel cell 100, a notification of the change can be provided such that the change is perceivable outside the microbial fuel cell system 1003. Since the result can be changed every time the voltage V, which is sensed with the sensing section 8, exceeds or becomes equal to or lower than the predetermined threshold voltage Vth, it is possible to obtain a sufficiently accurate result.

### Embodiment 51

FIG. 5 is a block diagram schematically showing a microbial fuel cell system 1004 in accordance with Embodiment 5. The following description will discuss the microbial fuel cell system 1004 in detail with reference to FIG. 5. The microbial fuel cell system 1004 shown in FIG. 5 is the same configuration as the microbial fuel cell system 1003 shown in FIG. 4, except for the following configuration.

Specifically, a control section 7 of the microbial fuel cell system 1004 includes a timer 70. The timer 70 is an internal clock that defines the time for the control section 7, and causes a sensing section 8 and/or a wireless transmission section 90 to operate at a predetermined point in time. In other words, the microbial fuel cell system 1004 includes at least one timer 70 configured to cause at least one of the sensing section 8 and the output section 9 to operate at predetermined time intervals.

The following description will discuss, with reference to (a) and (b) of FIG. 9, points in time at which the wireless transmission section 90 outputs the result of sensing. (a) of FIG. 9 is a graph showing an example of how a voltage (electromotive voltage) V of a microbial fuel cell 100 of the microbial fuel cell system 1004 changes with time. (b) of FIG. 9 is a graph showing an example of how an electric current I consumed by the control section 7 of the microbial fuel cell system 1004 changes with time.

As shown in (a) of FIG. 9, the voltage V is sensed at times ta, tb, tc, and td, each of which is a sensing time set in advance by the timer 70, and the sensed voltage is converted into data. Note that the interval between times ta and tb, the interval between times tb and tc, and the interval between times tc and td are equal in length to each other. In other words, the sensing section 8 operates at regular time intervals.

In the meantime, as shown in (b) of FIG. 9, an electric current value Id′, which is the value of the electric current that is always necessary even while the sensing section 8 and the wireless transmission section 90 are not operated, is smaller than the electric current value Id shown in (b) of FIG. 8.

According to (a) and (b) of FIG. 9, the control section 7 of the microbial fuel cell system 1004 is capable of providing a notification of the state of the microbial fuel cell 100 at a predetermined point in time such that the state is perceivable outside the microbial fuel cell system 1004.

In the microbial fuel cell system 1004, a time of sensing by the sensing section 8 and a time of output by the wireless transmission section 90 are in one-to-one correspondence. However, the sensing and the output do not need to be performed in one-to-one correspondence. For example, the following arrangement can be employed: a plurality of results of sensing with the sensing section 8 are stored in a memory (not shown) or the like; and all these results are transmitted at once from the wireless transmission section 90 via data transmission.

In the microbial fuel cell system 1004, the sensing section 8 and the wireless transmission section 90 do not need to be always maintained in a stand-by state. The sensing section 8 and the wireless transmission section 90 may be operated only at points in time corresponding to the respective times ta, tb, tc, and td. That is, in the control section 7, by separately supplying electricity to the timer 70 and to the sensing section 8 and the wireless transmission section 90, it is possible to cause (i) only the timer 70 to operate and (ii) the control section 7 to be in a sleep state except for the above points in time. Therefore, according to the microbial fuel cell system 1004, the always-necessary electric current can be reduced from the electric current value Id to the electric current value Id′.

### Embodiment 61

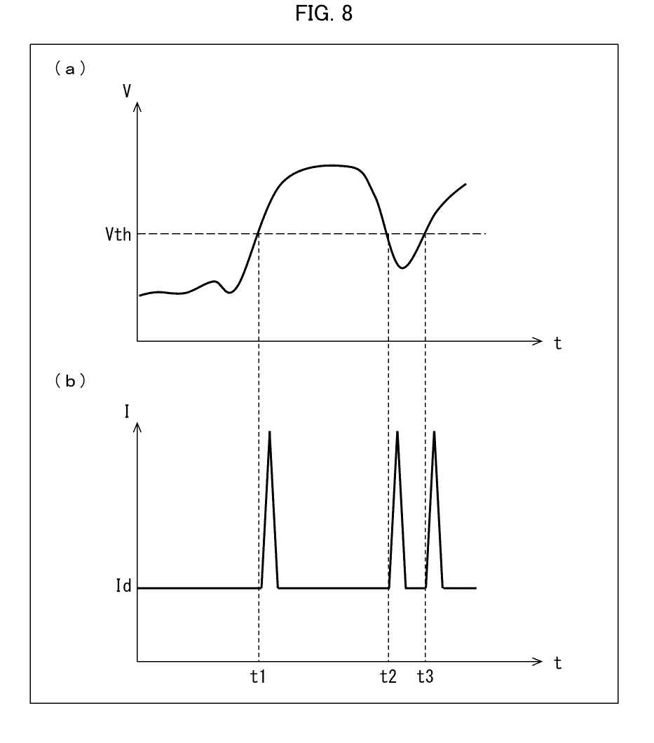

FIG. 6 is a block diagram schematically showing a microbial fuel cell system 1005 in accordance with Embodiment 6. The following description will discuss the microbial fuel cell system 1005 in detail below with reference to FIG. 6. The microbial fuel cell system 1005 shown in FIG. 6 is the same in configuration as the microbial fuel cell system 1003 shown in FIG. 4, except for the following configuration.

Specifically, a control section 7 of the microbial fuel cell system 1005 includes a display 91 instead of the wireless transmission section 90. The display 91 is one specific example of the output section 9 shown in FIG. 1. The display 91 is configured to provide a notification of a result of sensing with a sensing section 8 such that the result is perceivable outside the microbial fuel cell system 1005, by visually displaying the result.

The display 91 is preferably, for example, a liquid crystal screen. Alternatively, the display 91 can be electronic paper (microcapsules) which can keep changes in electric field as tracks. In such a case, by providing a notification of the state of the microbial fuel cell system 1005 only when the notification should be made, electricity consumption can be reduced.

According to the microbial fuel cell system 1005, a notification of change in electromotive force of a microbial fuel cell 100 is provided such that the change is perceivable outside the microbial fuel cell system 1005 through a visual display. The points in time at which the notification of change is provided, or the like, can be based on, for example, the times shown in (a) and (b) of FIG. 8 and (a) and (b) of FIG. 9.

In addition to the state of the microbial fuel cell 100 or that of the external environment, the display 91 can also display the number of times the electromotive force of the microbial fuel cell 100 has changed (the number of times a notification has been provided).

### Embodiment 7

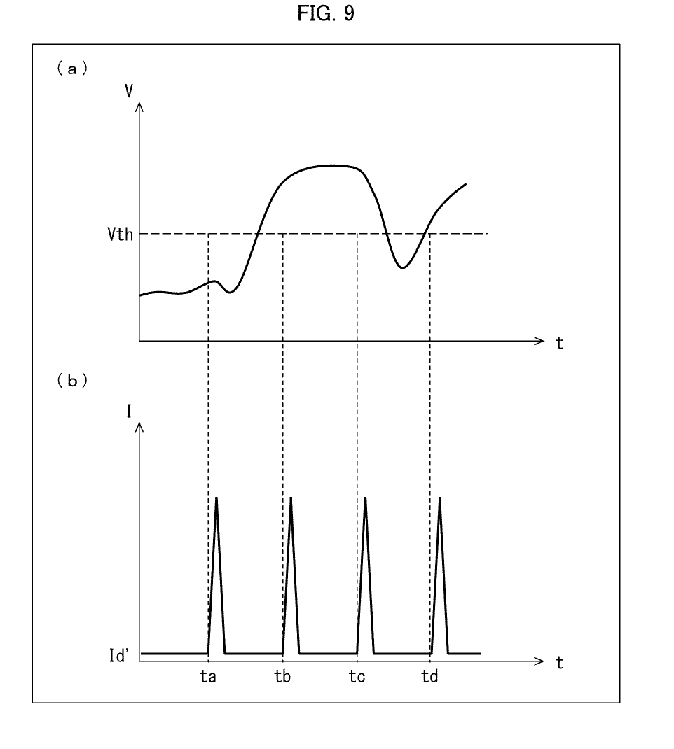

FIG. 7 is a block diagram schematically showing a microbial fuel cell system 1006 in accordance with Embodiment 7. The following description will discuss the microbial fuel cell system 1006 in detail with reference to FIG. 7. The microbial fuel cell system 1006 shown in FIG. 7 is the same in configuration as the microbial fuel cell system 1003 shown in FIG. 4, except for the following configuration.

Specifically, a control section 7 of the microbial fuel cell system 1006 includes an LED section 92 instead of the wireless transmission section 90. The LED section 92 is one specific example of the output section 9 shown in FIG. 1. The LED section 92 is configured to provide a notification of a result of sensing with a sensing section 8 such that the result is perceivable outside the microbial fuel cell system 1006, by visually indicating the result.

The LED section 92 is constituted by a single LED or a plurality of LEDs. The LED section 92 can be configured to change the illumination pattern according to the state of the microbial fuel cell system 1006. The LED section 92 can be configured to blink and, by the cycle of the blinking, provide a notification of the state of the microbial fuel cell system 1006 and/or a change thereof such that the state and/or the change is/are perceivable outside the microbial fuel cell system 1006.

According to the microbial fuel cell system 1006, a notification of change in electromotive force of a microbial fuel cell 100 is provided such that the change is perceivable outside the microbial fuel cell system 1006 through a visual display. The points in time at which the notification of change is provided, or the like, can be based on, for example, the times shown in (a) and (b) of FIG. 8 and (a) and (b) of FIG. 9.

In the microbial fuel cell system 1006, the sensing section 8 can be, for example, a booster circuit that boosts an input voltage in a case where the input voltage is equal to or greater than a certain voltage and outputs the voltage thus boosted. In such a case, the microbial fuel cell system 1006 can be configured such that, when a voltage inputted to the booster circuit serving as the sensing section 8 has exceeded a threshold Vth, the booster circuit boosts the voltage to a voltage with which the LED section 92 can light up and the exceeding of the threshold is notified by the lighting up of the LED section 92.

[Recap]

A microbial fuel cell system in accordance with a first aspect of the present invention includes: a microbial fuel cell; a sensing section configured to sense an electromotive force of the microbial fuel cell; and an output section configured to output a result of sensing with the sensing section, the sensing section and the output section being configured to be powered by the electromotive force of the microbial fuel cell.

According to the above configuration, the sensing section and the output section are powered by the electromotive force of the microbial fuel cell. This makes it possible to achieve a microbial fuel cell system in which a change in electromotive force of a microbial fuel cell is sensed and visualized by use of electric supply from the microbial fuel cell.

The microbial fuel cell system in accordance with a second aspect of the present invention can be configured such that, in the first aspect of the present invention, the sensing section is configured to change the result according to whether a sensed value, which corresponds to a magnitude of the electromotive force of the microbial fuel cell, is greater than a predetermined threshold.

According to the above configuration, the result can be changed every time the sensed value exceeds or becomes equal to or lower than the predetermined threshold. This makes it possible to obtain a sufficiently accurate result.

The microbial fuel cell system in accordance with a third aspect of the present invention can be configured to further include, in the first or second aspect of the present invention, at least one timer configured to cause at least one of the sensing section and the output section to operate at predetermined time intervals.

The above configuration allows the sensing section and the output section to be in a sleep state while they are not operated. This makes it possible to reduce the always-necessary electric current.

The microbial fuel cell system in accordance with a fourth aspect of the present invention can be configured such that, in any one of the first through third aspects of the present invention, the output section is configured to provide a notification of the result such that the result is perceivable outside the microbial fuel cell system, by visually displaying the result.

The microbial fuel cell system in accordance with a fifth aspect of the present invention can be configured such that, in the first through third aspects of the present invention, the output section is configured to provide a notification of the result such that the result is perceivable outside the microbial fuel cell system, via wireless communication.

The above configuration makes it possible to provide a notification of the result of sensing with the sensing section such that the result is perceivable outside the microbial fuel cell system.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

2: Negative electrode
3: Positive electrode
4: Ion-conducting section
5: Microbes-containing layer
6: Air layer
8: Sensing section
9: Output section
70: Timer
90: Wireless transmission section (output section)
91: Display (output section)
92: LED section (output section)
100: Microbial fuel cell
1000 to 1006: Microbial fuel cell system

1. A microbial fuel cell system, comprising:
a microbial fuel cell;
a sensing section configured to sense an electromotive force of the microbial fuel cell; and
an output section configured to output a result of sensing with the sensing section,
the sensing section and the output section being configured to be powered by the electromotive force of the microbial fuel cell.

2. The microbial fuel cell system as set forth in claim 1, wherein the sensing section is configured to change the result according to whether a sensed value, which corresponds to a magnitude of the electromotive force of the microbial fuel cell, is greater than a predetermined threshold.

3. The microbial fuel cell system as set forth in claim 1, further comprising:
at least one timer configured to cause at least one of the sensing section and the output section to operate at predetermined time intervals.

4. The microbial fuel cell system as set forth in claim 1, wherein the output section is configured to provide a notification of the result such that the result is perceivable outside the microbial fuel cell system, by visually displaying the result.

5. The microbial fuel cell system as set forth in claim 1, wherein the output section is configured to provide a notification of the result such that the result is perceivable outside the microbial fuel cell system, via wireless communication.
